(19) United States
(12) Patent Application Publication
(10) Pub. No.: US 2006/0145515 A1
(43) Pub. Date: Jul. 6, 2006

(54) Bodyshell

(75) Inventors: Kai Visel, Stuggart (DE); Achim Kurz-Ritter Von Sporschill, Remshalden (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuggart (DE)

(21) Appl. No.: 10/541,701

(22) PCT Filed: Nov. 27, 2003
(86) PCT No.: PCT/EP03/13371

§ 371 Date: Feb. 8, 2006

(30) Foreign Application Priority Data
Jan. 10, 2003 (DE) 10300574.9

(51) Int. Cl. B62D 31/00

(52) U.S. Cl. 296/181.1

(57) ABSTRACT

A body shell of a motor vehicle, in particular of a front and/or a rear region of a motor vehicle, has longitudinal members and crossmembers connected to one another and designed as a flexible bearing system. A standard shell construction of the body shell is provided, and differently sized reinforcing members are attachable to the crossmembers in the front and/or rear region of the body shell for stiffening the standard shell construction (9) to satisfy different country-specific homologation requirements.

### BACKGROUND OF THE INVENTION

The present invention relates to a body shell of a motor vehicle, in particular of a front and/or a rear region of a motor vehicle, having longitudinal members and crossmembers which are connected to one another and are designed as a flexible bearing system, a standard shell construction of the body shell being provided, and differently sized reinforcing members being attachable to the crossmembers in the front and/or rear region of the body shell and stiffening the standard shell construction in order to satisfy different country-specific homologation requirements.

The automobile industry, desires to produce parts which can be used as flexibly as possible at minimum costs. In order also to realize this with regard to bumper arrangements, the automotive manufacturers have constructed numerous bumper arrangements which are simply designed and include various structural stiffening means and, as a result, are intended to satisfy the respective country-specific homologation requirements, such as, for example, energy absorption capacity and deformability.

There is, however, a problem in satisfying these respective country-specific requirements without undertaking changes to the body shell. One individual country-specific adaptation of the body shell in regard of rigidity results in non-uniform production and therefore greatly increased costs.

### SUMMARY OF THE INVENTION

An object of the present invention, is to rapidly and flexibly adapt the body shell to the respective country-specific homologation requirements with simple body shell modifications.

The present invention is based on the general concept of providing a standard shell construction of a body shell to which differently sized reinforcing members can be attached in the front and/or rear region, which reinforcing members reinforce a crossmember in the front and/or rear region of the standard shell construction in such a manner that the latter satisfies the different country-specific homologation requirements with respect to bumper arrangements attached thereto. Particularly advantageous in this case is that only one standard shell construction is provided for all countries, which is adapted to the particular country-specific homologation requirements in a further installation operation, by attachment of the reinforcing member to the crossmember of the standard shell construction.

In the case of the conventional design, differently sized crossmembers are constructed, in accordance with the particular country-specific requirements. As a result different crossmembers have to be supplied and processed during the production process, and thus a severe nonuniformity of the production process is caused. By contrast, the solution according to the present invention makes possible premanufacture of a standard shell construction which is constructed in an identical manner for all countries, and attachment of differently sized reinforcing members to it, depending in each case on country-specific requirements. Thereby, the production process is tightened up to save costs and time. In addition, it is possible to react flexibly to modification requirements which only occur during the production process, without having to undertake complex and therefore expensive modifications to the body shell.

In one advantageous refinement of the solution according to the present invention, provision may be made for the reinforcing member to be formed from plastic or from a metallic material. The use of plastics in motor vehicle construction, in particular even in the case of impact- and/or vibration-stressed components, is widespread nowadays.

Plastic reinforcing members arranged on the crossmembers of the vehicle also have the advantage of being corrosion-resistant. This has a favorable effect particularly in the motor vehicle underbody region which is subject to a severe amount of stress due to spray water and road salt. Furthermore, plastic parts can be shaped virtually as desired and can be produced cost-effectively. By contrast, a formation of the reinforcing member from a metallic material affords the advantage of the latter being easily connectable to the crossmember of the motor vehicle by a welding connection or the like.

A particularly advantageous development of the invention has a bonding connection, in particular a sheetlike bonding connection, via which the reinforcing member is connected to the crossmember. Powerful adhesives have already made many appearances in the connecting technology in automobile construction and in the process have proven a durable and reliable connecting technique. A bonding connection in principle enables the connection of different materials, such as, for example, metal and plastic, and can be used without subjecting the materials to be connected to a thermal load, as is the case, for example, with a welding connection. In addition, bonding connections are regarded as particularly protective of material, because the thermal inevitable stresses mentioned, as occur, for example, when heating during welding, are avoided.

Expediently, provision may be made for a foam system of different thickness to be attachable to the reinforcing member. It is precisely in the region of bumper arrangements that there are particularly great differences in respect of the country-specific homologation requirements. In some countries, such as, for example, the United States, bumper arrangements have to be capable of withstanding an impact with a predetermined impact energy without them or the motor vehicle being damaged, whereas bumper arrangements in other countries have merely to satisfy esthetic purposes. It is therefore particularly favorable to be able to react flexibly to the particular requirements with differently sized foam systems.

In the case of one particularly advantageous embodiment, the reinforcing member is supported by one end in each case on the longitudinal members of the standard shell construction and/or has at least one folding bead for stiffening the reinforcing member. In the event of an impact, the supporting of the reinforcing member on the longitudinal members of the standard shell construction affords the advantage that not only are the bumper arrangement and the crossmember and the reinforcing member used for energy absorption, but also that the entire standard shell construction is available for the deformation or energy absorption. A folding bead arranged on the reinforcing member stiffens the latter and therefore reinforces the energy-absorbing effect by way of an increased deformation which can have a particularly favorable effect in the event of a crash.

The features mentioned above and those which have yet to be explained below can be used, not only in the respectively stated combination but also, in other combinations or on their own without departing from the scope of the present invention.

### BRIEF DESCRIPTION OF THE DRAWINGS

Other objects, advantages and novel features of the present invention will become apparent from the following detailed description of the invention when considered in conjunction with the accompanying drawings.

FIG. 1 is a perspective view of a reinforcing member according to the present invention, and

FIG. 2 is a rear view of a motor vehicle with the reinforcing member of FIG. 1.

### DETAILED DESCRIPTION OF THE DISCLOSURE

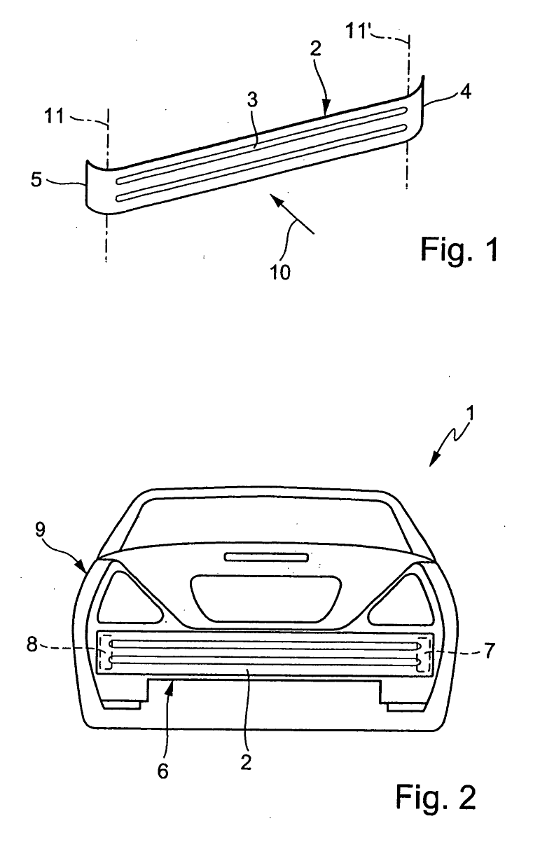

As seen in FIG. 1, a reinforcing member 2 according to the present invention has an essentially rectilinear shape in the manner of a profiled member and, at its one end region 4 and/or at its other end region 5 and/or 11, may be curved slightly about a bending axis 11 which is arranged transversely with respect to the longitudinal direction of the member and is situated parallel to the plane of the member, in order to be matched thereby to the contour of a crossmember 6 of the type shown in FIG. 2. In principle, another shape corresponding to the contour of the crossmember 6 is also contemplated, with it being possible for the reinforcing member 2 to be configured as a profiled part. The reinforcing member 2 is shaped such that it has, as an individual component and in conjunction with the crossmember 6, an increased resistance to torsion, bending and compression.

Beginning at the one end region 4, at least one folding bead 3 runs in the longitudinal direction of the reinforcing member 2 as far as the other end region 5 and increases the rigidity of the reinforcing member 2. Therefore, more deformation resistance is provided with respect to a force acting in the direction of arrow 10. The arrangement of two or more folding beads 3 is, however, also contemplated (see FIG. 1). The at least one folding bead 3 may also be engaged in a bead situated in a corresponding position on the crossmember.

The reinforcing member 2 may be made from plastic or from a metallic material. A formation from aluminum or another suitable material is, however, also contemplated, with the reinforcing member 2 being a part which is unmachined with regard to its surface.

The reinforcing member 2 is connected either in a spotlike or sheetlike manner to the crossmember 6 which is arranged at its one end 4 in the transverse direction of the vehicle on a left longitudinal member 8 and at its other end 5 on a right longitudinal member 7 (see FIG. 2). The crossmember 6 is part of the body shell 1 and stiffens the latter in the transverse direction of the vehicle. At the same time, a bumper arrangement is arranged on the crossmember 6 and, in the event of a crash, is supported on the crossmember 6.

FIG. 2 illustrates, an arrangement of the crossmember 6 in the transverse direction of the vehicle on a rear end region of the body shell 1. The reinforcing member 2 can be connected to the crossmember 6 via a bonding connection, in particular via a sheetlike bonding connection, via a screw connection or via a welding connection. It is central to the present invention for the reinforcing member 2 to be attached subsequently, in a further installation step, to the already premanufactured standard shell construction 9, with the result that the country-specific homologation requirements are only satisfied by the arrangement of a corresponding reinforcing member 2.

In order to satisfy the country-specific homologation requirements, the reinforcing member 2 may be differently sized in accordance with the requirements or else may have individual features in respect of shape and/or material. The possibility of forming the reinforcing member 2 to be stiffer or stronger precisely in the region of the force-introduction points from the bumper arrangement, i.e. in the region of the greatest bending moments to be anticipated, appears particularly important in this connection.

The reinforcing member 2 is supported according to FIG. 2 by its two end regions 4, 5 on the longitudinal members 7, 8 of the standard shell construction 9. As a result, an introduction of force into the body shell 1 is brought about in the event of a crash. In principle, however, it is also contemplated for the reinforcing member 2 to only cover part of the crossmember 6 and to not extend as far as the two longitudinal members 7, 8.

In addition, a foam system (not illustrated) of different thickness can be attached to the reinforcing member 2. The foam system is part of a bumper arrangement (likewise not illustrated), and can also be matched to country-specific characteristics and is used for energy absorption in the event of a crash. Due to the material structure and shaping, the foam system can be deformed plastically and at the same time transmit the impact force to the reinforcing member 2 or the crossmember 6 via supporting elements (not illustrated).

The statements made have primarily been illustrated using the example of a crossmember 6 or reinforcing member 2 arranged on the rear region of a vehicle; they can, however, also be transferred to a front region of the vehicle.

In summary, essential features of the present invention include just one standard shell construction 9 of a body shell 1 to which differently sized reinforcing members 2 can be attached in the front and/or rear region, as a result of which the different country-specific homologation requirements for the rigidity of bumper arrangements and the supporting of the same on the body shell 1 are satisfied, and the reinforcing member 2 formed either from plastic or a metallic material for connection to the crossmember 6 by a bonding connection, a screw connection or a welding connection.

The foregoing disclosure has been set forth merely to illustrate the invention and is not intended to be limiting. Since modifications of the disclosed embodiments incorporating the spirits and substance of the invention may occur to persons skilled in the art, the invention should be construed to include everything within the scope of the appended claims and equivalents thereof.

1-9. (canceled)

10. A body shell of a motor vehicle, having longitudinal members and crossmembers connected to one another and forming a flexible bearing system, comprising:
a standard shell construction of the body shell, and
differently sized reinforcing members configured to be attachable to the crossmembers in at least one of a front and rear region of the body shell to stiffen the standard shell construction for satisfying selected country-specific homologation requirements.

11. The shell as claimed in claim 10, wherein the reinforcing member is plastic.

12. The shell as claimed in claim 10, wherein the reinforcing member is a metallic material.

13. The shell as claimed in claim 10, wherein the reinforcing member is connected to the crossmember via a bonding connection.

14. The shell as claimed in claim 13, wherein the bonding connection is a sheetlike bonding connection.

15. The shell as claimed in claim 13, wherein the reinforcing member is plastic.

16. The shell as claimed in claim 13, wherein the reinforcing member is a metallic material.

17. The shell as claimed in claim 10, wherein the reinforcing member is connected to the crossmember via a screw connection.

18. The shell as claimed in claim 17, wherein the reinforcing member is plastic.

19. The shell as claimed in claim 13, wherein the reinforcing member is a metallic material.

20. The shell as claimed in claim 10, wherein the reinforcing member is connected to the crossmember via a welding connection.

21. The shell as claimed in claim 10, wherein a foam system of selected thickness can be attached to the reinforcing member.

22. The shell as claimed in claim 10, wherein the reinforcing member is supported by one respective end on the longitudinal members of the standard shell construction.

23. The shell as claimed in claim 10, wherein the reinforcing member has at least one folding bead for stiffening the reinforcing member.

24. The shell as claimed in claim 23, wherein the reinforcing member is plastic.

25. The shell as claimed in claim 23, wherein the reinforcing member is a metallic material.

26. The shell as claimed in claim 23, wherein the reinforcing member is connected to the crossmember via a bonding connection.

27. The shell as claimed in claim 23, wherein the reinforcing member is connected to the crossmember via a screw connection.

28. The shell as claimed in claim 23, wherein the reinforcing member is connected to the crossmember via a welding connection.

29. The shell as claimed in claim 23, wherein a foam system of selected thickness can be attached to the reinforcing member.
